(19) United States
(12) Patent Application Publication
(10) Pub. No.: US 2020/0367547 A1
(43) Pub. Date: Nov. 26, 2020

(54) CONTROLLED RELEASE OF PHASEOLAMIN COMPOSITIONS

(71) Applicant: PharmaChem Laboratories, LLC, Kearny, NJ (US)

(72) Inventor: Mitch SKOP, Cioster, NJ (US)

(73) Assignee: PharmaChem Laboratories, LLC, Kearny, NJ (US)

(21) Appl. No.: 16/496,597

(22) PCT Filed: Mar. 20, 2018
(86) PCT No.: PCT/US2018/023331

§ 371 Date: Sep. 23, 2019

Related U.S. Application Data
(60) Provisional application No. 62/474,154, filed on Mar. 21, 2017.

(51) Int. Cl. A23L 33/105; A23L 33/135; A23L 33/14; A23L 33/165; A23L 33/00; A23L 33/185; A21D 2/02; A21D 2/36; A21D 10/00; A21D 13/06; A21D 2/26

(52) U.S. Cl. CPC A23L 33/105; A23L 33/135; A23L 33/14; A23L 33/165; A23L 33/30; A23L 33/185; A23Y 2220/03; A21D 2/362; A21D 10/002; A21D 13/06; A21D 2/266; A23V 2002/00; A21D 2/02

(57) ABSTRACT

The invention is directed to a controlled release composition containing phaseolamin and a mineral, where the mineral is bound by a glycoprotein matrix. The composition may also contain stabilizers and/or additives and/or microorganisms.

This application claims priority to U.S. Provisional Application Ser. No. 62/474,154 filed on May 21, 2017, the disclosure of which is incorporated herein by reference in its entirety.

### BACKGROUND OF THE INVENTION

Controlled release delivery of an active ingredient is highly desirable for providing a constant level of an active ingredient in an individual.

Phaseolamin is a glycoprotein found mainly in white and red kidney beans and is known to be an amylase inhibitor. Amylase is an enzyme responsible for the breakdown or digestion of starch. Starch is the main source of carbohydrates in the human diet. The digestion of starch begins in the mouth. Alpha-amylase present in saliva randomly hydrolyzes the glucosidic bonds of starch except for the outermost bonds and those next to branches.

By the time thoroughly chewed food reaches the stomach, the average chain length of starch is reduced from several thousand to less than eight glucose units. The acid level in the stomach inactivates the alpha-amylase. Further digestion of starch continues in the small intestine by pancreatic alpha-amylase, which is similar to that of salivary alpha-amylase.

Decreasing the absorption of carbohydrates by inhibiting the digestion of starch is a very promising strategy in the fields of, for example weight loss and diabetes mellitus. From a dietary standpoint, it is important to target the breakdown of starch since starch is a relatively nonessential nutrient, which provides calories with fairly little benefit. Furthermore, as starch is broken down into simple sugars and absorbed from the digestive tract, the pancreas is triggered to produce insulin. Increase in insulin production causes an individual to feel hunger.

A large percentage of the United States population suffers from obesity. Obesity has been associated with many illnesses, such as cardiovascular disease, respiratory illness including asthma, sleep apnea, Pick-Wichian syndrome, diabetes mellitus and pulmonary hypertension.

Approximately 90% of all obese individuals who try to lose weight fail. One reason is that the majority of obese individuals are reluctant to give up eating certain foods, including starches (i.e., pasta, bread, and potatoes). Therefore, a dietary supplement that effectively inhibits the digestion and breakdown of starch, without harmful side effects, will be beneficial in helping these individuals achieve weight loss.

In addition to assisting weight loss, inhibiting the digestion or breakdown of starch may also be beneficial in illnesses such as, for example, diabetes mellitus. Currently, between 120 and 140 million people worldwide suffer from diabetes mellitus and by the year 2025, it is estimated that this number may double. Much of the increase in individuals suffering from diabetes mellitus will occur in developing countries due to population aging, unhealthy diets, obesity, and a sedentary lifestyle.

One of the biggest problems with taking supplements, such as phaseolamin, for weight loss, diabetes, etc., is compliancy. Thus, there remains a need for a composition in which the beneficial phaseolamin is in a controlled, slow-release form, and provides the inhibition of starch metabolism over an extended period of time.

### SUMMARY OF THE INVENTION

In one embodiment of the invention, a controlled release composition comprising phaseolamin and a mineral, where the mineral is bound by a glycoprotein matrix is provided. The composition may further comprise stabilizers and/or additives. The composition may also further comprise microorganisms.

In another embodiment, microorganisms produce the glycoprotein matrix of the composition. The microorganisms include yeast. The yeast can include Saceharomyces cervisiae.

The invention provides a composition where the microorganisms include bacteria, for example, Lactobacillus, more specifically, Lactobacillus acidophillus or Bacterium bifidus. The composition according to the invention can contain both yeast and bacteria.

The invention contemplates adding the composition to a baking mix, such as for example, pancake, waffle, bread, biscuit and cookie mix.

In an embodiment of the invention, the mineral is vanadium or chromium or both. In accordance with the invention, the controlled release is selected from the group consisting of diffusion, dissolution osmotic, ion-exchange, floating, bio-adhesive, stimuli inducing and matrix.

The invention also contemplates a method for inhibiting dietary starch by administering an effective amount of a composition comprising phaseolamin and a mineral, where the mineral is bound by a glycoprotein matrix, and where the composition is delivered via controlled release.

### DETAILED DESCRIPTION OF THE INVENTION

In accordance with the present invention, a composition is provided which includes phaseolamin and a mineral, wherein the mineral is bound to a glycoprotein matrix. The composition of the invention provides improved stability and bioactivity characteristics of the mineral, in conjunction with the starch inhibition properties of phaseolamin.

The glycoprotein matrix of the present invention is bound to at least one mineral. The glycoprotein matrix and mineral can be associated with each other physically and/or chemically, such as by chemical reaction, and/or secondary chemical bonding, e.g., Van der Waals forces, etc. Not being bound by theory, it is believed that the glycoprotein matrix may be bound to the mineral by weak covalent bonds.

The composition can contain essentially any percentage of mineral and phaseolamin as desired. For example, the percentage of mineral can vary between 0.1 and 99% by weight of the composition depending upon the mineral and the desired result in the host. The percentage of phaseolamin can vary between 0.1 and 99% by weight of the composition depending upon desired result in the host.

Glycoprotein Matrix: The glycoprotein matrix is the glycoprotein to which the mineral is bound. Glycoprotein is a composite material made of a carbohydrate group and a simple protein. A glycoprotein matrix is a molecular network comprised of a plurality of glycoprotein molecules bound together.

The carbohydrate in the glycoprotein can be any suitable carbohydrate, such as a monosaccharide, disaccharide, oligosaccharide, or polysaccharide. Oligosaccharide is preferred. The protein of the glycoprotein can be any suitable polypeptide. The ratio of carbohydrate to protein in the glycoprotein matrix can vary, for example, from 99:1 to 1:99 by weight. A ratio of approximately 1:1 is preferred.

The ratio of glycoprotein matrix to mineral can also vary. It is preferred that the ratio of glycoprotein matrix to mineral will be such that all or nearly all of the mineral in the composition is bound by glycoprotein matrix. To ensure that essentially all of the mineral is bound, higher ratios of glycoprotein matrix to mineral can be used.

The invention also contemplates a composition where there may be insufficient glycoprotein to bind the entire amount of the mineral. In such cases, the ratio of glycoprotein matrix to mineral can be less.

In a preferred embodiment, the source of the glycoprotein matrix is a microorganism and, therefore, a preferred composition of the invention will include microorganisms. At the end of the manufacturing process of the composition, these microorganisms are usually inactive.

The glycoprotein matrix can be bound to the mineral by allowing the microorganism to ferment, in the presence of the mineral. As used herein, fermentation is the process by which microorganisms metabolize raw materials, such as amino acids and carbohydrate, to produce glycoprotein.

The microorganisms produce glycoprotein both intracellularly and extracellularly The intracellular glycoprotein will mainly be located in the cytoplasm of the microorganism or become part of the microorganism's physical structure. The glycoprotein from the microorganism that forms the glycoprotein matrix is mainly extracellular and, therefore, is available to be bound to the mineral. Intracellular glycoprotein can also be made accessible for binding to the mineral by rupture of the microorganisms after glycoprotein production.

Microorganisms that produce a glycoprotein matrix include, but are not limited to, yeast and some bacteria. A preferred yeast is Saccharomyces cervisiae. Bacteria that produce glycoprotein include bacteria within the genus Lactobacillus. For example, such bacteria include, but are not limited to, Lactobacillus acidophillus, Lactobacillus bulgaricus, Lactobacillus caucasicus, and Bacterium bifidus. Preferred bacteria include Lactobacillus acidophillus, and Bacterium bifidus.

Combinations of microorganisms can be used provided that at least one of the microorganisms produces glycoprotein. When using combinations of microorganisms, the growth of one type of microorganism should not prevent the growth of the other. For example, various types of different yeast that produce glycoprotein can be used. Also, yeast and bacteria can be combined to produce glycoprotein. This combination is particularly advantageous because various types of bacteria, such as Lactobacillus acidophillus, also produce glycoprotein.

Stabilizers and Additives: The composition of the invention can also include stabilizers and/or additives. Stabilizers and additives can include, for example, pharmaceutically acceptable buffers, excipients, diluents, surfactants, adjuvants, flavorings, and the like. The amounts of such additives can be determined by one skilled in the art.

Additives can also include, for example, natural sources of the phaseolamin and mineral to be administered. Other additives can be added which, for example, improve the viability of the microorganisms that produce the glycoprotein or increase the yield of glycoprotein that becomes bound to the phaseolamin and mineral. For example, salts can be added in order to increase the viability of the microorganism. Such salts include, but are not limited to, calcium carbonate, ammonium sulfate, and magnesium sulfate. Calcium carbonate is preferred. The amount of salt added to the microorganism solution should be sufficient to obtain the desired result of improving the viability of the organism, as is known in the art. A preferred range of salt added to the microorganism solution is between about 25 to about 150 grams of salt per 375 grams of microorganism, such as Saccharomyces cervisiae. Approximately 40 g of salt per 375 gram of microorganism is most preferred.

The composition of the invention can be manufactured so as to be biocompatible. Since the mineral is to be ingested, the microorganism used to produce the glycoprotein matrix should be suitable for consumption by mammals, especially humans. Examples of such microorganisms include Lactobacillus acidophillus and Saccharomyces cervisiae. The mineral can also include pharmaceutically acceptable buffers, excipients, diluents, adjuvants, flavorings, and the like.

Minerals: The compositions of the present invention also include a mineral. A mineral suitable for a composition of the present invention can be any mineral that is beneficial to a host. Preferred minerals are those that aid in controlling dietary starch absorption and/or carbohydrate cravings, such as, for example, vanadium and chromium.

Vanadium is an ultra-trace element that is a potent nonselective inhibitor of protein tyrosine phosphatases. Vanadium has been shown to mimic many of the metabolic actions of insulin both in vivo and in vitro. For the purposes of this invention, vanadium may be naturally occurring, semisynthetic or synthetic. Preferably, the vanadium is bound by a glycoprotein matrix to form a complex.

Chromium is an essential trace element that has been shown to improve the efficiency of insulin and control dietary starch absorption and carbohydrate cravings. For the purposes of this invention, chromium can be naturally occurring, semisynthetic or synthetic. Preferably, the chromium is bound by a glycoprotein matrix to form a complex.

Phaseolamin: Phaseolamin is derived from Phaseolus vulgaris, or the white kidney bean. The primary function of phaseolamin is to cause temporary, safe, side-effect free malabsorption of dietary starch. Not being bound by theory, it is believed that phaseolamin binds and neutralizes alpha-amylase. By neutralizing alpha-amylase, absorption of the carbohydrate is inhibited. As will be discussed below, phaseolamin is effective for inducing weight loss.

Alpha-amylase is a naturally occurring starch enzyme that is responsible for the breakdown of starches. For example, in humans, dietary starches must be broken down into smaller components, for example, glucose, in order to be utilized by the body.

Therefore, by neutralizing the body's enzyme that breaks down starches into usable components, the body is unable to use those starches and ultimately excretes them. In addition, starches that are not broken down into smaller components, such as glucose, do not trigger the production of insulin.

Amylase is a digestive tract enzyme that breaks down starch into small units capable of being further degraded into glucose which is used as fuel for normal metabolism and body homeostasis. Clinical use of inhibitors of amylase has widespread appeal because a reduction of starch digestion will influence carbohydrate uptake in individuals in need thereof.

Not being bound by theory, it is believed that in a composition of the present invention, the phaseolamin acts synergistically with both the vanadium and chromium glycoprotein complexes to enhance the effects of the phaseolamin, vanadium and chromium.

Insulin is a hormone naturally produced by the body that is key to controlling blood glucose levels. Circulating blood caries glucose that provides fuel for the cells. Getting glucose into the cells requires insulin, which is produced in the pancreas by beta cells. Normally, the pancreas produces just enough insulin to handle the body's needs. This is not the case with diabetics, as will be discussed below.

Carbohydrate consumption causes an abnormal rise in insulin. Excess insulin triggers hunger and cravings, creating a vicious cycle. One way to end the cycle is to reduce or eliminate the intake of carbohydrates. This approach has had very little or no success in inducing weight loss for the long term. It is also extremely difficult for individuals with impairment of glucose utilization, such as diabetes mellitus, to restrict their intake of carbohydrates.

The compositions of the present invention induce weight loss by inhibiting the absorption of carbohydrate. In addition, the compositions control cravings associated with carbohydrate absorption. By inhibiting absorption if dietary starch and controlling cravings associated with carbohydrate absorption, the compositions of the present invention are effective in inducing weight loss.

In addition, the compositions of the invention reduce the amount of insulin required by an individual suffering from diabetes mellitus. Accordingly, as will be discussed below, phaseolamin is an effective and beneficial treatment for overweight, obese and/or morbidly obese individuals and for individuals suffering from diabetes mellitus.

Dietary Starch: Dietary starch is any consumable starch and is a mixture of glucans (polymers of glucose). Some examples of dietary starch sources include pasta, rice, grains, potatoes and cereals. In accordance with the present invention, dietary starch is composed of, for example, amylose and/or amylopectin.

Amylose is an essentially unbranched polymer of α-glucose residues which are joined by 1-4 glycosidic linkages. There can be about 1000 glucose residues per amylose molecule. Amylose forms a helical coil structure and is only slightly soluble in water due to the internal —OH groups. Amylopectin is a highly branched polymer of α-glucose residues. Amylopectin usually consists of about 20-25 glucose residues.

Other types of dietary starch include, for example, cellulose, pectin, hydrocolloids or gums and maltodextrins. Consumption of dietary starch has been linked to weight gain, diabetes mellitus, and various gastrointestinal conditions including, for example, irritable bowel syndrome.

Dosage and Administration: The glycoprotein matrix compositions containing a mineral can be administered topically or systemically. Systemic administration can be enteral or parenteral. Enteral administration is preferred. For example, the compositions can easily be administered orally. Liquid or solid (e.g., tablets, gelatin capsules) formulations can be employed. The formulation can include pharmaceutically acceptable excipients, adjuvants, diluents, or carriers.

The compositions can be administered in chewable tablet granulations, with or without sugar, in powdered drink mixes, chewing gum and baking products. In a preferred embodiment, because the compositions are stable under baking temperatures, the compositions are effectively administered in baking mixes such as pancakes, waffles, breads, biscuits or cookies.

In accordance with the present invention, an effective amount of a claimed composition is any amount known to those skilled in the art. Preferably, an effective amount is administered to a host just prior to, during or shortly after consuming a starch-rich meal.

Host: In a preferred embodiment the host is a mammal. Mammals include, for example, humans, as well as pet animals such as dogs and cats, laboratory animals such as rats and mice, and farm animals such as horses and cows. Humans are most preferred.

A host in need of weight loss is, for example, any host where the weight of the host is not beneficial for its health. Another example of a host in need of weight loss is, for example, a host that is unhappy with it's appearance due to excess weight. Some examples of hosts in need of weight loss include, but are not limited to, hosts that suffer from diabetes mellitus and overweight individuals.

A host is considered overweight when the body weight of the mammal is greater than the ideal body weight according to the height and body frame of the host. The ideal body weight of a host is known to those skilled in the art. A host is considered in need of weight loss if its body weight is at least about 10%, preferably at least about 30%, more preferably at least about 60%, and most preferably at least about 100% greater than their ideal body weight.

A host, for example, a human, is considered obese when its body weight is increased beyond the limitation of skeletal and physical requirement as the result of excessive accumulation of fat in the body. Obesity can be the result of many different forces, such as, for example, overeating or a medical condition. A medical condition that could result in obesity is, for example, a low metabolic rate.

Morbid obesity occurs when an individual's weight is two, three or four times the ideal weight for that individual, and is so-called because it is associated with many seriously life-threatening disorders.

Many different approaches have been advanced for the treatment of overweight, obese and/or morbidly obese individuals with little success and great side-effects. The present invention provides a novel resolution which will effectively aid in inducing weight loss. The claimed composition comprising phaseolamin and a mineral bound by a glycoprotein matrix is effective in blocking starch absorption and controlling carbohydrate cravings.

The claimed composition comprising phaseolamin and a mineral, such as vanadium or chromium or both, bound by a glycoprotein matrix will provide inhibition the absorption of starch and control carbohydrate cravings.

The composition of the invention may also be used in a mammal suffering from an impairment of glucose utilization, for example, diabetes mellitus. The impairment in glucose utilization may occur as a result of a deficiency in the production of insulin by the pancreas, or by ineffectiveness of the insulin produced to utilize glucose. As discussed above, insulin is necessary to the transport of glucose from the blood into cells.

In diabetes mellitus, insulin is either absent, in short supply or unable to perform its job efficiently. If glucose cannot get into the cells, it accumulates in the blood creating increased blood glucose.

All clinicians recognize that dietary factors play a role in the treatment of diabetes mellitus. In many diabetic individuals, weight loss may cure or significantly improve diabetes mellitus.

A number of meal planning systems are used in conventional diabetes care settings. One of the most popular systems is carbohydrate counting which involves maintaining a relatively constant level of carbohydrates from day to day. By doing so, the insulin needs of the diabetic individual are more or less predictable and constant.

Individuals suffering from diabetes mellitus usually need to ingest insulin to aid in the absorption of blood glucose into cells. Often, after consuming a carbohydrate rich meal, a diabetic's insulin requirements may markedly increase to deal with the high blood glucose levels.

Accordingly, by inhibiting the absorption of dietary starch, a composition of the present invention will effectively decrease the insulin requirements of a diabetic host.

The following examples are provided to assist in a further understanding of the invention. The particular materials and conditions employed are intended to be further illustrative of the invention and are not limiting upon the reasonable scope thereof.

There are many different methods used to obtain sustained release of phaseolamin and a mineral according to the claimed invention. Any known method for controlling the release of phaseolamin and mineral can be used. The following are suitable examples of methods for sustaining the release of phaseolamin and a mineral.

Diffusion systems rate release is dependent on the rate at which the phaseolamin and mineral dissolves through a barrier which is usually a type of polymer. Diffusion systems can be broken into two subcategories, reservoir devices and matrix devices.

Reservoir devices coat the phaseolamin and mineral with polymers and in order for the reservoir devices to have sustained release effects, the polymer must not dissolve and let the phaseolamin and mineral be released through diffusion. The rate of reservoir devices is altered by changing the polymer.

Matrix devices forms a matrix (phaseolamin and mineral mixed with a gelling agent) where the phaseolamin and mineral is dissolved/dispersed. The phaseolamin and mineral is usually dispersed within a polymer and then released by undergoing diffusion. However, to make the phaseolamin and mineral have sustained release in this device, the rate of dissolution of the phaseolamin and mineral within the matrix needs to be higher than the rate at which it is released.

Dissolution systems work by having the system dissolved slowly in order for the phaseolamin and mineral to have sustained release properties which can be achieved by using appropriate salts and/or derivatives as well as coating the phaseolamin and mineral with a dissolving material. The phaseolamin and mineral is covered with some slow dissolving coat, and eventually releases the phaseolamin and mineral. Instead of diffusion, the release of the phaseolamin and mineral depends on the solubility and thickness of the coating. Because of this mechanism, the dissolution will be the rate limiting factor for release of the phaseolamin and mineral. Dissolution systems can be broken down to subcategories called reservoir devices and matrix devices.

The reservoir device coats the phaseolamin and mineral with an appropriate material which will dissolve slowly. It can also be used to administer beads as a group with varying thickness, making the drug release in multiple times creating a sustained release.

The matrix device has the phaseolamin and mineral in a matrix and the matrix is dissolved instead of a coating. It can come either as phaseolamin and mineral impregnated spheres or phaseolamin and mineral impregnated tablets.

Osmotic systems are where a membrane does not allow the phaseolamin and mineral to diffuse outside the membrane, but the body fluid on the exterior of the membrane can diffuse into the membrane, allowing the phaseolamin and mineral to release through channels within the membrane. Some phaseolamin and minerals are enclosed in polymer-based tablets with a laser-drilled hole on one side and a porous membrane on the other side. Stomach acids push through the porous membrane, thereby pushing the phaseolamin and mineral out through the laser-drilled hole. In time, the entire phaseolamin and mineral dose releases into the system while the polymer container remains intact, to be excreted later.

In the ion-exchange method, the resins are cross-linked water-insoluble polymers that contain ionisable functional groups that form a repeating pattern of polymers, creating a polymer chain. The phaseolamin and mineral is attached to the resin and is released when an appropriate interaction of ions and ion exchange groups occur. The area and length of the phaseolamin and mineral release and number of cross-link polymers dictate the rate at which the phaseolamin and mineral is released, determining the sustained release effect.

A floating system is a system where the phaseolamin and mineral floats on gastric fluids due to low-density. The density of the gastric fluids is about 1 mg/mL; thus, the phaseolamin and mineral/tablet administered must have a smaller density. The buoyancy will allow the system to float to the top of the stomach and release at a slower rate without worry of excreting it. Many types of forms of drugs use this method such as powders, capsules, and tablets.

The matrix system is the mixture of materials with the phaseolamin and mineral, which will cause the phaseolamin and mineral to slow down. This system has several subcategories: hydrophobic matrices, lipid matrices, hydrophilic matrices, biodegradable matrices, and mineral matrices.

A hydrophobic matrix is phaseolamin and mineral mixed with a hydrophobic polymer. This causes sustained release because the phaseolamin and mineral, after being dissolved, will have to be released by going through channels made by the hydrophilic polymer.

A hydrophilic matrix will go back to the matrix as discussed before where a matrix is a mixture of phaseolamin and mineral with a gelling agent. The polymers used can be broken down into categories: cellulose derivatives, non-cellulose natural, and polymers of acrylic acid.

A lipid matrix uses wax or similar materials. Phaseolamin and mineral release happens through diffusion through, and erosion of, the wax and tends to be sensitive to digestive fluids.

Biodegradable matrices are made with unstable, linked monomers that will erode by biological compounds such as enzymes and proteins.

A mineral matrix which generally means the polymers used are obtained in seaweed.

Examples of stimuli that may be used to bring about release include pH, enzymes, light, magnetic fields, temperature, ultrasonics, and osmosis.

The following examples are provided to assist in a further understanding of the invention. The particular materials and conditions employed are intended to be further illustrative of the invention and are not limiting upon the reasonable scope thereof.

### Example 1 Preparation of Mineral+Glycoprotein Matrix (GPM) Complex

This example demonstrates the preparation of a mineral (i.e., chromium or vanadium) plus glycoprotein matrix (GPM) complex to yield a mineral+GPM complex. The method employs preparing, in a first container, an aqueous solution of USP inorganic mineral salt and adding a peptone made of amino acids.

In a second container an active yeast solution is prepared. Active baker's yeast, Saccharomyces cervisiae added to water to form an aqueous solution. Maltose and gum acacia are then added. The first container containing the mineral is then inoculated very slowly into the active yeast solution to form a live fermented solution. The mixture is allowed to ferment for four to six hours. To promote yeast growth, plant proteins and carbohydrates are added Proteolytic enzyme, such as papain, is then added.

Lactobacillus acidophillus is added to the live fermented solution and allowed to ferment for about 2 hours. Active fermentation is then stopped by beating the solution to 160-170° F. for three hours. The fermented mineral solution is then homogenized in a shearing pump (Charles Ross & Sons Corp.) for approximately 1-2 hours and spray dried (NIRO, Nicholas Engineers Research Corp.) for approximately 4 hours. The resulting product is a powder containing the mineral GPM complex.

### Example 2 Preparation of Phaseolamin

Whole dried non-genetically modified organism (GMO) Phaseolus vulgaris beans were inspected for cleanliness. Upon quality control approval of the beam, the dried beans were milled and placed in a solvent, preferably water, or an alcohol-water mixture.

Phaseolamin was extracted from the bean fraction multiple times under strict standard operating procedures as are known to those in the art, such as, for example, affinity chromatography. The extracted phaseolamin was then spray dried and tested for bacterial contamination, mesh (i.e., particle size), moisture content, potency, and organoleptics (i.e., physical characteristics, such as, color, taste, odor, powder, and liquid).

### Example 3 Preparation of Phaseolamin with Mineral+GPM

Complex Phaseolamin was added to a mineral+GPM complex (obtained from Example 1) and mixed together. The resulting mixture yielded a composition comprising phaseolamin and a mineral+GPM complex. This method may be used to prepare, for example, 1) phaseolamin with chromium+GPM complex; 2) phaseolamin with vanadium+GPM complex; and 3) phaseolamin with chromium+GPM complex and vanadium+GPM complex. The methods for preparing the above listed compositions are briefly described below.

Briefly, to prepare phaseolamin with a chromium+GPM complex, 4500 mgs of phaseolamin was added to 3 mgs of chromium+GPM complex and mixed together. The resulting mixture yielded 6 μgs of elemental chromium per 4.5 g of phaseolamin.

To prepare phaseolamin with a vanadium+GPM complex, phaseolamin at 450 mgs was added to 3 mgs of vanadium+GPM complex and mixed together. The resulting mixture yielded 6 μg of elemental vanadium per 4.5 g of phaseolamin.

To prepare phaseolamin with chromium+GPM complex and vanadium+GPM complex, 4500 mgs of phaseolamin at was added to 1.5 mgs of chromium+GPM complex and 1.5 mgs of vanadium+GPM complex and mixed together. The resulting mixture yielded 3 μg of elemental chromium and 3 μg of elemental vanadium per 4.5 g of phaseolamin.

### Example 4 Efficacy of Phaseolamin

To study the efficacy of phaseolamin, five males and five females (ages 21 to 57) participated in a double-blind placebo-controlled crossover study. All subjects were instructed to go about their usual daily routines throughout the study. After an overnight fast, the participants were sampled for blood and then given in a random manner either:

Group 1)(placebo) a starch meal consisting of 4 slices of white bread (60 grams of carbohydrate) with 42 grams of soybean oil margarine and 4 grams of Sweet N′ Low spread on the bread; or Group 2) a starch meal consisting of 4 slices of white bread (60 grams of carbohydrate) with 42 grams of soybean oil margarine and 4 grams of Sweet N′ Low spread on the bread; plus 1.5 grams of PHASEOLAMIN 2250M (Phaseolus vulgaris extract sold by PharmaChem Laboratories. Inc., Kearny, N.J.).

Plasma glucose was measured by a commercial enzyme kit (Sigma Chemical Company) from blood drawn at baseline, and every 30 minutes for 4 hours. After one week the regimen was repeated where the starch meal containing PHASEOLAMIN 2250™ was administered to the subjects group 1 and the subjects in group2 were administered the starch meal without PHASEOLAMIN 2250™.

The subjects were normo-glycemic as measured by fasting glucose concentration which averaged 98 mg/dl for the placebo and 104 for the PHASEOLAMIN 2250™ starch meal. From 60 to 120 minutes after consumption of the starch meal, the change in plasma glucose of the PHASEOLAMIN 2250™ group from the baseline was % to ⅓ of the level of the placebo group (FIG. 1). PHASEOLAMIN 2250™ consumption caused the plasma glucose to return to baseline values 20 minutes earlier than the placebo without PHASEOLAMIN 2500™.

The average area under the plasma glucose time curve from 0 to 150 minutes, which is a measure of absorption and metabolism, was 57% lower with PHASEOLAMIN 2250™. Plotting the average change in glucose concentration from 30 minutes to 210 minutes, the area under the curve was positive for the placebo but negative for PHASEOLAMIN 2250™.

This indicates that very little of the glucose from the starch in the bread was absorbed when co-ingested with PHASEOLAMIN 2250M and that the glucose was cleared very rapidly. No side effects were observed in subjects treated with PHASEOLAMIN 2250™.

We claim:

1. A controlled release composition comprising phaseolamin, a mineral, and microorgansims, wherein said mineral is bound by a glycoprotein matrix, wherein said microorganisms produce said glycoprotein matrix, and wherein said microorganisms include yeast and bacteria.

2. A composition according to claim 1, wherein said yeast includes Saccharomyces cervisiae.

3. A composition according to claim 1, wherein said bacteria includes Lactobacillus.

4. A composition according to claim 3, wherein said bacteria includes Lactobacillus acidophillus or Bacterium bifidus.

5. A composition according to claim 1, further comprising stabilizers and/or additives.

6. A composition according to claim 1, wherein said composition is added to a baking mix.

7. A composition according to claim 6, wherein said baking mix is selected from the group consisting of pancake, waffle, bread, biscuit and cookie mix.

8. A composition according to claim 6, wherein said mineral is vanadium or chromium or both.

9. A composition according to claim 6, wherein the controlled release is selected from the group consisting of diffusion, dissolution, osmotic, ion-exchange, floating, bio-adhesive, stimuli inducing and matrix.

10. A method for inhibiting absorption of dietary starch in a host, said method comprising administering to said host, an effective amount of a controlled release composition comprising phaseolamin and a mineral, and wherein said mineral is bound by a glycoprotein matrix.

11. A method according to claim 10, wherein said composition further comprises microorganisms.

12. A method according to claim 11, wherein said microorganisms produce said glycoprotein matrix.

13. A method according to claim 11, wherein said microorganisms include yeast.

14. A method according to claim 13, wherein said yeast includes Saccharomyces cervisiae.

15. A method according to claim 11, wherein said microorganisms include bacteria.

16. A method according to claim 15, wherein said bacteria includes Lactobacillus.

17. A method according to claim 16, wherein said bacteria includes Lactobacillus acidophillus or Bacterium bifidus.

18. A method according to claim 11, wherein said microorganisms include yeast and bacteria.

19. A method according to claim 10, further comprising stabilizers and/or additives.

20. A method according to claim 10, wherein said dietary starch is amylose.

21. A method according to claim 10, wherein said host is a human.

22. A method according to claim 10, wherein said human is obese.

23. A method according to claim 22, wherein said human is morbidly obese.

24. A method according to claim 21, wherein said human suffers from an impairment of glucose utilization.

25. A method according to claim 24, wherein said impairment of glucose utilization is diabetes mellitus.
